(19) United States
(12) Patent Application Publication
(10) Pub. No.: US 2015/0137543 A1
(43) Pub. Date: May 21, 2015

(54) Cricket Tongs

(71) Applicant: Joseph S. Sporn, New York, NY (US)

(72) Inventor: Joseph S. Sporn, New York, NY (US)

(21) Appl. No.: 14/057,355

(22) Filed: Nov. 18, 2013

(51) Int. Cl. B25B 9/02

(52) U.S. Cl. CPC B25B 9/02
USPC 294/99.2

(57) ABSTRACT

A tongs device for grasping an insect without injury comprising a pair of biased arms interconnected at their proximal ends and spaced apart at their distal ends and which arms are biased apart and including a plurality of clustered elastic and resilient bristles carried by each of the distal ends and disposed in opposing relationship to each other.

The present invention involves modification of traditional tongs to permit the grasping of a cricket, grasshopper or similar creature without injury to the living creature.

Among other places, pet supply businesses are called upon to handle live insects such as crickets and grasshoppers which are used to feed reptiles, birds, mantids, spiders, rodents and other species that may be resident in the pet supply store that feed on these insects. In some instances it may be necessary to merely transport the insects from one location to another. In other instances the insect may be picked up and fed directly to the consumer. In either case it is humanely desirable to provide a device for grasping the insect in a manner that does not injure or maim the prospective meal.

### DESCRIPTION OF THE DRAWINGS

FIG. 1 is a perspective view of the tongs of the present invention.

FIG. 2 is a perspective view of the tongs of the present invention depicting the grasping of a cricket for the purpose of feeding it to a reptile.

### DETAILED DESCRIPTION OF A PREFERRED FORM

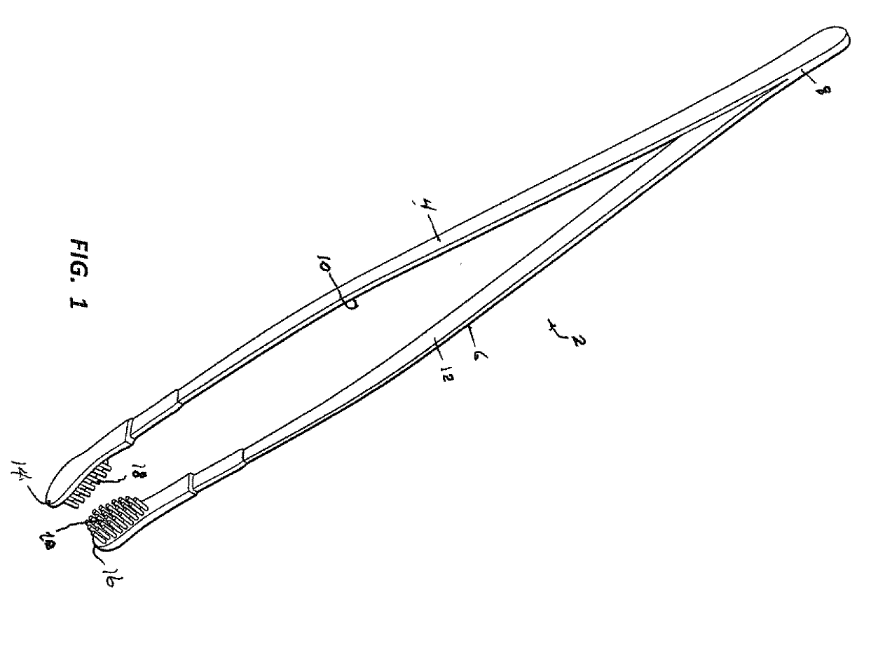

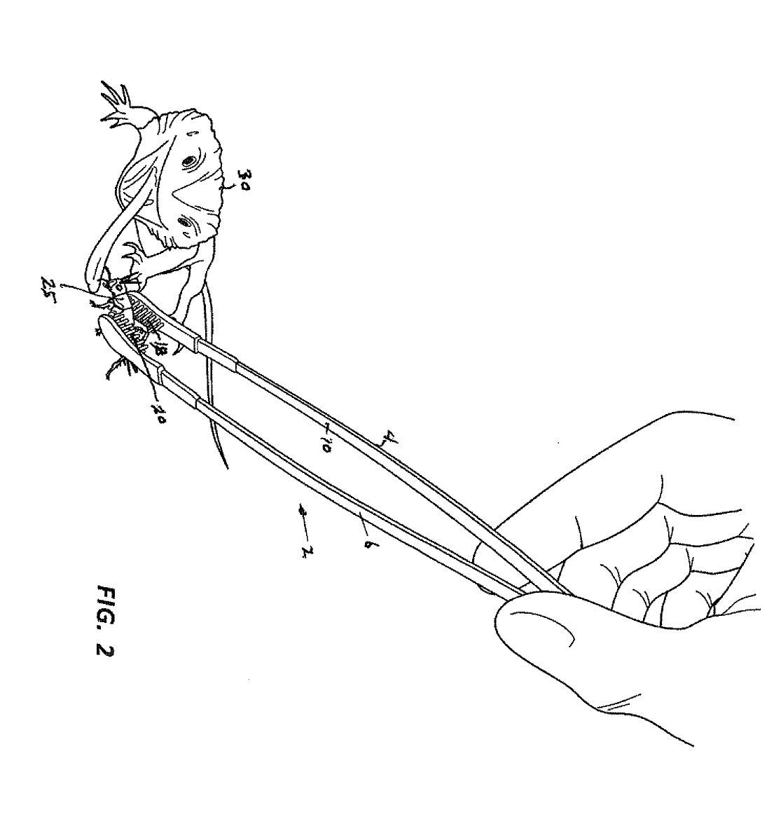

FIGS. 1 and 2 both illustrate the structure of the tongs 2 of the present invention as comprising a pair of biased arms 4 and 6 that are interconnected at their proximal ends 8. In the preferred form, but not a limited or necessary form of construction, the arms 4 and 6 have flat inside surfaces 10 and 12 that face each other.

At the distal ends 14 and 16 of the arms, and disposed on the flat opposing inside surfaces of each arm, are clusters of elastic bristles 18 and 20. The bristles are constructed of soft rubber or of a silicon compound so that the compressive force of the bristles relative to the human pressure applied to close the tongs is regulated to provide a grasping function while at the same time providing a more humane transport of a cricket, grasshopper or other insect of the Orthoptera order. The elastic soft bristles are spaced apart sufficiently that the legs and wings of the insect may fit between the bristles, but if the legs are not positioned between them the pressure of the bristles is only enough to provide a grasping force without injury to the insect.

FIG. 2 illustrates a typical transport of a cricket 25 which is being humanely grasped between the bristles 18 and 20 of the tongs 2 in order to convey the cricket to the mouth of eager lizard 30.

I claim:

1. Tongs, comprising,
a pair of arms each having first and second flat sides and proximal and distal ends and being joined together at their proximal ends and biased to be spaced apart at their distal ends and where the respective first sides of each arm are in opposing relationship,
a plurality of loosely clustered elastic bristles disposed on the first side of each arm proximate the distal end of the arm.

2. The tongs of claim 1 where the bristles comprise rubber.

3. The tongs of claim 1 where the bristles comprise silicon.

4. A device for grasping an insect of the order Orthoptera without injury comprising,
a pair of biased arms each having proximal and distal ends and interconnected at their proximal ends and biased to be spaced apart and free at the distal ends,
a plurality of clustered elastic and resilient bristles carried by each of the free distal ends and disposed in opposing relationship to each other.
